(19) United States
(12) Patent Application Publication
(10) Pub. No.: US 2006/0252324 A1
(43) Pub. Date: Nov. 9, 2006

(54) Cleaning wipe

(75) Inventors: Jean Julemont, Heusy-Verviers (BE); Natacha Szalapa, Neupre (BE); Didier Donnal, Aywaille (BE)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 11/122,366

(22) Filed: May 5, 2005

(51) Int. Cl. B32B 27/04; D04H 13/00; D04H 1/00

(52) U.S. Cl. 442/97; 442/327; 442/415

(57) ABSTRACT

A wipe which comprises: a nonwoven fabric impregnated with a cleaning composition; the nonwoven fabric having a basis weight of from about 70 to about 90 grams per square meter; a high basis weight area, and a low basis weight area, a weight ratio of the high basis weight area to the low basis weight area from about 1.5 to about 4.0, and a surface area ratio of the high basis weight area to the low basis weight area from about 0.65 to about 1.60; the high basis weight areas and the low basis weight areas being distributed along the surface of the non-woven fabric in a repeating pattern; the repeat lengths of the pattern being from 2 to 6 mm in the cross direction (CD) and from 2 to 6 mm in the machine direction (MD), and preferably 4 mm in both MD and CD directions.

### FIELD OF THE INVENTION

The present invention relates to a floor cleaning wipe comprised of a multi-basis weight nonwoven fabric having a three-dimensional structure impregnated with a cleaning composition.

### BACKGROUND OF THE INVENTION

Nonwoven fabrics are used in a wide variety of applications where the engineered qualities of the fabric can be advantageously employed. These types of fabrics differ from traditional woven or knitted fabrics in that the fabrics are produced directly from a fibrous mat, eliminating the traditional textile manufacturing processes of multi-step yarn preparation, and weaving or knitting.

U.S. Pat. No. 3,485,706, to Evans, the disclosure of which is hereby incorporated by reference, discloses processes for hydroentanglement of nonwoven fabrics. U.S. Pat. No. 5,098,764 to Drelich et al., the disclosure of which is hereby incorporated by reference, describes methods to impart images or patterns to the entangled fabric by effecting hydroentanglement on three-dimensional image transfer devices.

Nonwoven fabrics have received wide acceptance for general purpose wiping, and it is known, for example, from U.S. Pat. Nos. 6,270,878 and 6,168,852 that wipes having a substrate may contain a surfactant for cleaning.

A characteristic of a wipe is its Substrate Surface Deposition Efficacy (SSDE). A wipe's SSDE is generally the ability of the wipe to clean a surface until the amount of available liquid is exhausted from the wipe or the wipe does not deliver enough liquid to the surface to be cleaned, or that liquid deposited onto a surface evaporates almost immediately (i.e., within a second or seconds). Another characteristic of a wipe is its Durability and Gliding (DOG). A wipe's DOG refers to its ease of use in cleaning a surface. For example, if a wipe has poor DOG, it may deteriorate due to friction and abrasion upon cleaning. A wipe's SSDE and DOG may be readily quantified with a Durability and Deposition (DAD) test method which measures the surface area that a nonwoven fabric may be able to clean without substantial deterioration of the substrate until the amount of available cleaner impregnated within the nonwoven fabric is exhausted or the nonwoven fabric does not deliver enough cleaner to the surface to be cleaned, or the cleaner deposited onto a surface evaporates almost immediately (i.e., within a second or seconds). If a wipe is designed for use on large surface areas, it would be advantageous for the wipe to have a relatively large DAD value. If the wipe is removably attached to a mopping device, a low DAD value would result in frequent changing of the wipe, which is undesirable to consumers. Accordingly, there is a need in the art for a nonwoven fabric impregnated with a cleaning agent that has a superior DAD value.

DAD may be affected by the type or fibers utilized in the nonwoven fabric, the basis weight of the materials, and the degree of impregnation level. A highly saturated substrate allows for an increased DAD value, but the effect of liquid dripping out of the substrate requires a box type of packaging for the wipe, which is more expensive to manufacture and ship. Accordingly, there is a need in the art for a nonwoven fabric impregnated with a cleaning agent that can be readily packaged and inexpensively shipped.

### SUMMARY OF THE INVENTION

The present invention is generally directed to a three-dimensional nonwoven material impregnated with a cleaning agent which is suitable to wipe surfaces. The wipe disclosed herein may be used for several purposes. For example, the wipe may be used as a floor wipe, facial wipe, paper towel, baby wipe, an adult wipe, a hard surface cleaner, etc. The intended use of the wipe does not limit the final product.

The invention provides a wipe comprising:
a nonwoven fabric impregnated with a cleaning composition;
the nonwoven fabric having a basis weight of from about 70 to about 90 grams per square meter; a high basis weight area, and a low basis weight area, the weight ratio of the high basis weight area to the low basis weight area being from about 1.5 to about 4.0, and the surface area ratio of the high basis weight area to the low basis weight area being from about 0.65 to about 1.60; the high basis weight areas and the low basis weight areas being distributed along the surface of the non-woven fabric in a repeating pattern; the repeat lengths of the pattern being from 2 to 6 mm in the cross direction (CD) and from 2 to 6 mm in the machine direction (MD), and preferably 4 mm in both MD and CD directions.

The cleaning composition may contain an anionic surfactant, at least one nonionic surfactant, a short chain amphiphile, an inorganic magnesium salt, and water. The cleaning composition may also comprise a zwitterionic surfactant, and other components either to provide additional effects or to make the prduct more attractive to consumers. The following are mentioned by way of example: antibacterial agents, preservatives, colors or dyes, enzymes, proteins and pH adjusting agents.

### DETAILED DESCRIPTION OF THE INVENTION

In accordance with the present invention, a multi-basis weight nonwoven fabric is impregnated with a cleaning composition. For cleaning compositions intended for use in the home, the nonwoven fabric and cleaning composition should be cosmetically acceptable, i.e., non-toxic, hypoallergenic, etc. Additionally, the nonwoven fabric and cleaning composition should be chemically compatible with one another.

A multi-basis weight substrate, such as a multi-basis weight nonwoven fabric, is used in the invention. The multi-basis weight nonwoven fabric has regions of high and low basis weight, and optionally intermediate basis weight regions. The high and low basis weight areas are respectively distributed along the surface of the non-woven fabric to form a repeating pattern. The repeat lengths of the pattern are from 2 to 6 mm in the cross direction (CD) and from 2 to 6 mm the machine direction (MD) and preferably 4 mm in both MD and CD directions.

The high basis weight regions may provide strength to the non-woven fabric and the low basis weight regions may provide for transfer of the cleaning composition to the surface to be cleaned.

A multi-basis weight substrate may be made according to U.S. Pat. Nos. 5,277,761 to Phan et al.; the disclosure of which is incorporated herein by reference.

In one embodiment of the invention, the wipe comprises:

(a) from about 20% to 30% weight of a nonwoven fabric which comprises from about 60% to 30% by weight polyester fibers and from about 40% to 70% weight viscose fibers, the nonwoven fabric having a basis weight within the range of about 70 to 90 grams per square meter and areas of multi-basis weight including a high basis weight area and low basis weight area. The basis weight ratio between the high basis weight areas and the low basis weight areas is in the range of about 1.5 to 4.0, and the surface area ratio between the high basis weight area and the low basis weight area is within the range of about 0.65 to 1.60; and

(b) from about 70% to 80% by weight of a cleaning composition.

The cleaning composition may comprise one or more detersive surfactants such as an anionic, nonionic, zwitterionic, amphoteric and cationic surfactants.

Suitable water-soluble non-soap, anionic surfactants used in the instant cleaning compositions include those surface-active or detergent compounds which contain an organic hydrophobic group containing generally 8 to 26 carbon atoms and preferably 10 to 18 carbon atoms in their molecular structure and at least one water-solubilizing group selected from the group of sulfonate, sulfate and carboxylate so as to form a water-soluble detergent. Usually, the hydrophobic group will include or comprise a C₈-C₂₂ alkyl, alkyl or acyl group. Such surfactants are employed in the form of water-soluble salts and the salt-forming cation usually is selected from the group consisting of sodium, potassium, ammonium, magnesium and mono-, di- or tri-C₂-C₃ alkanolammonium, with the sodium, magnesium and ammonium cations again being preferred.

Examples of suitable sulfonated anionic surfactants are the well known higher alkyl mononuclear aromatic sulfonates such as the higher alkyl benzene sulfonates containing from 10 to 16 carbon atoms in the higher alkyl group in a straight or branched chain, C₈-C₁₅ alkyl toluene sulfonates and C₈-C₁₅ alkyl phenol sulfonates.

A preferred sulfonate is linear alkyl benzene sulfonate having a high content of 3—(or higher) phenyl isomers and a correspondingly low content (well below 50%) of 2—(or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, preferably 12 to 21 carbon atoms and having the formula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. Preferred olefin sulfonates contain from 14 to 16 carbon atoms in the R alkyl group and are obtained by sulfonating an a-olefin.

Other examples of suitable anionic sulfonate surfactants are the paraffin sulfonates containing 10 to 20, preferably 13 to 17, carbon atoms. Primary paraffin sulfonates are made by reacting long-chain alpha olefins and bisulfites and paraffin sulfonates having the sulfonate group distributed along the paraffin chain are shown in U.S. Pat. Nos. 2,503,280; 2,507,088; 3,260,744; and 3,372,188.

Examples of suitable anionic sulfate surfactants are the C₈-C₁₈ alkyl sulfate salts the ethoxylated C₈-C₁₈ alkyl ether sulfate salts having the formula R(OC₂H₄)ₙ OSO₃M wherein n is 1 to 12, preferably 1 to 5, and M is a metal cation selected from the group consisting of sodium, potassium, ammonium, magnesium and mono-, di- and triethanol ammonium ions. The alkyl sulfates may be obtained by sulfating the alcohols obtained by reducing glycerides of coconut oil or tallow or mixtures thereof and neutralizing the resultant product.

On the other hand, the ethoxylated alkyl ether sulfates are obtained by sulfating the condensation product of ethylene oxide with a C₈-C₁₈ alkanol and neutralizing the resultant product. The alkyl sulfates may be obtained by sulfating the alcohols obtained by reducing glycerides of coconut oil or tallow or mixtures thereof and neutralizing the resultant product. The ethoxylated alkyl ether sulfates differ from one another in the number of moles of ethylene oxide reacted with one mole of alkanol. Preferred alkyl sulfates and preferred ethoxylated alkyl ether sulfates contain 10 to 16 carbon atoms in the alkyl group.

The ethoxylated C₈-C₁₂ alkylphenyl ether sulfates containing from 2 to 6 moles of ethylene oxide in the molecule also are suitable for use in the inventive compositions. These surfactants can be prepared by reacting an alkyl phenol with 2 to 6 moles of ethylene oxide and sulfating and neutralizing the resultant ethoxylated alkylphenol.

Other suitable anionic surfactants are the C₉-C₁₅ alkyl ether polyethenoxyl carboxylates having the structural formula R(OC₂H₄)ₙOX COOH wherein n is a number from 4 to 12, preferably 5 to 10 and X is selected from the group consisting of
CH₂, (C(O)R₁ and

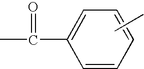

wherein R₁ is a C₁-C₃ alkylene group. Preferred compounds include C₉-C₁₁ alkyl ether polyethenoxy (7-9)C(O)CH₂CH₂COOH, C₁₃-C₁₅ alkyl ether polyethenoxy (7-9) 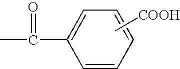
and C₁₀-C₁₂ alkyl ether polyethenoxy (5-7) CH2COOH. These compounds may be prepared by condensing ethylene oxide with appropriate alkanol and reacting this reaction product with chloracetic acid to make the ether carboxylic acids as shown in U.S. Pat. No. 3,741,911 or with succinic anhydride or phthalic anhydride. Obviously, these anionic surfactants will be present either in acid form or salt form depending upon the pH of the final composition, with salt forming cation being the same as for the other anionic surfactants.

The amine oxide semi-polar nonionic surfactants comprise compounds and mixtures of compounds having the formula 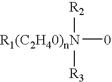
wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10. Particularly preferred are amine oxides of the formula: 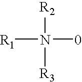
wherein R₁ is a C₁₂₋₁₆ alkyl and R₂ and R₃ are methyl or ethyl. The above ethylene oxide condensates, amides, and amine oxides are more fully described in U.S. Pat. No. 4,316,824 which is hereby incorporated herein by reference.

The water soluble nonionic surfactants useful for the invention are commercially well known and include the primary aliphatic alcohol ethoxylates, secondary aliphatic alcohol ethoxylates, alkylphenol ethoxylates and ethylene-oxide-propylene oxide condensates on primary alkanols, such as Plurafacs (BASF). The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water-soluble nonionic detergent. Further, the length of the polyethenoxy chain can be adjusted to achieve the desired balance between the hydrophobic and hydrophilic elements.

The nonionic detergent class includes the condensation products of a higher alcohol (e.g., an alkanol containing about 8 to 18 carbon atoms in a straight or branched chain configuration) condensed with about 5 to 30 moles of ethylene oxide, for example, lauryl or myristyl alcohol condensed with about 16 moles of ethylene oxide (EO), tridecanol condensed with about 6 to moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

A preferred group of the foregoing nonionic surfactants are the Neodol ethoxylates (Shell Co.), which are higher aliphatic, primary alcohol containing about 9-15 carbon atoms, such as C₉-C₁₁ alkanol condensed with 2.5 to 10 moles of ethylene oxide (NEODOL 91-2.5 or −5 or −6 or −8), C₁₂₋₁₃ alkanol condensed with 6.5 moles ethylene oxide (Neodol 23-6.5), C₁₂₋₁₅ alkanol condensed with 12 moles ethylene oxide (Neodol 25-12), C₁₄₋₁₅ alkanol condensed with 13 moles ethylene oxide (Neodol 45-13), and the like.

Solvents may be present in the cleaner. These solvents will, advantageously, provide an enhanced cleaning. Suitable solvents for use herein include propylene glycol derivatives such as n-butoxypropanol or n-butoxypropoxypropanol, water-soluble CARBITOL® solvents which are compounds of the 2-(2-alkoxyethoxy)ethanol class wherein the alkoxy group is derived from ethyl, propyl or butyl. A preferred water-soluble carbitol is 2-2-butoxyethoxy)ethanol also known as butyl carbitol.

The final essential ingredient in the cleaner composition is water. The proportion of water in the cleaning compositions is generally in the range of 70 wt. % to 99.0 wt. %.

The cleaning composition can further comprise additional water-soluble or dispersible materials that do not adversely affect the stability of the composition. One such material that is typically included is a water-soluble electrolyte. Examples of such electrolytes include sodium chloride, calcium chloride, sodium sulfate, magnesium sulfate, and sodium bicarbonate. The electrolyte will typically be present in the range of from about 1 to about 20% of the cleaning composition.

Other water-soluble or dispersible materials that can be present include thickeners and viscosity modifiers. Suitable thickeners and viscosity modifiers include polyacrylic and hydrophobically modified polyacrylic resins such as Carbopol and Pemulen, starches such as corn starch, potato starch, cellulose ethers such as hydroxypropyl cellulose, hydroxyethyl cellulose, carboxymethyl cellulose, and the like. Cellulosic polymers are manufactured by Dow Chemical under the tradename Methocel. These thickeners and viscosity modifiers will typically be included in a concentration in the range of from about 0.05 to about 0.5% of the composition.

The cleaning compositions are prepared by simple batch mixing at 25° C.-30° C. The nonwoven fabric is impregnated with the liquid cleaning composition by means of a positive impregnation process. The liquid is positively fed into the water insoluble substrate through a controlled gear pump and injection bar at a ratio of about 5 grams of liquid cleaning composition to about 1 gram of the nonwoven fabric.

The nonwoven fabric typically is formed from about 40 wt. % to 70 wt. % of viscose fibers and 60 wt. % to 30 wt. % of polyester fibers. The nonwoven fabric, due to its weight and composition, has high absorption capacity, and in addition allows smooth release of water to the floor and consequently ensures the highest possible DAD values. A preferred substrate is a Lidro 80 gram per square meter Structured FL70T non woven made by Jacob Holm whose composition is about 65% of viscose fiber and about 35% of polyester fiber. The basis weight is measured by Edana Recommended Test Method (ERT) 40.3-90. The book source for the test method is published by EDANA (European Disposable And Nonwovens Association) based in Brussels. The non-woven fabric has a tensile strengnth of 89 N/5 cm along the MD, and 22 N/5 cm along the CD, as measured by ERT 20.2-89. The non-woven fabric has a elongation breakage at 45% MD and 136% CD, as measured by ERT 20.2-89. The non-woven fabric has an absorption capacity of 1281%, as measured by ERT 10.3-99.

The hydroentanglement binding process to manufacture the non-woven is performed by passing the fiber web on a patterned grooved cylinder. Given the low and high deep grooved areas, the high energy waterjets disturb the fiber uniformity, creating areas of high and low fiber density.

### BRIEF DESCRIPTION OF THE DRAWINGS

FIG. 1 is a plan view of the non-woven fabric.

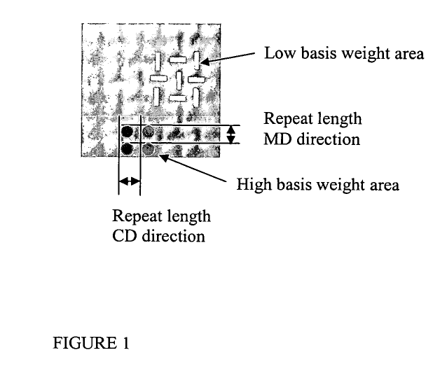

Referring to FIG. 1 the high basis weight area is an area of high fiber density and the low basis weight area is an area of low fiber density. The created pattern has a “repeat” length in both Machine direction (MD) and Cross direction (CD). The repeat pattern length is the distance after which the pattern is repeated.

The following example illustrates superior DAD value of the wipe described. The exemplified compositions are illustrative only and do not limit the scope of the invention. Unless otherwise specified, the proportions in the examples and elsewhere in the specification are by weight.

### EXAMPLE 1

The following floor cleaning wipes were made by the aforementioned process: Wipes were impregnated with the following cleaning composition:

| Ingredient | Wt. % |
|---|---|
| short chain amphiphile: Hexanol EO5:1 | 0.036 |
| nonionic surfactant: Plurafac LF300 | 0.036 |
| anionic surfactant: paraffin sulfonate | 0.09 |
| nonionic surfactant: C9-C11 alcohol EO7.5-8:1 | 0.072 |
| Perfume | 0.04 |
| Preservative: iodopropynyl butyl carbamate | 0.027 |
| MgSO₄—7H2O | 0.03 |
| Water | Balance |

The non-woven fabrics tested are as follows:

| | A | B |
|---|---|---|
| Manufacturer | Jacob Holm | Jacob Holm |
| Product Brand | Lidro | Norafin |
| Basis Weight | 80 g/m² | 100 g/m² |
| Multi-basis weight | Yes | No |
| Impregnation level | 5.5 g cleaner/g substrate | 5.0 g cleaner/g substrate |

Product A comprises a non-woven fabric in accordance with the invention.

Each impregnated wipe is fit to an implement. The DAD value is the number of square meters of a vinyl type floor that are possible to clean until one can notice that liquid is exhausted from the wipe, or which results in no wetting of the floor, or the deterioration of the substrate.

Results observed are as follows:

| | A | B |
|---|---|---|
| DAD (m) | 7 | 6 |

The test indicates a DAD ratio between product A and B to be 1.167. The test was confirmed in additional 91 separate tests between products A and B whereby the average DAD ratio between product A and B was 1.14 (95% CL 1.09-1.19).

The Average DAD ratio between product A and B is 1.14 with confidence limits at 95% CL (Confidence Level) of 1.14-0.05:1.09 and 1.14+0.05=1.19. This confirms the lab test results where the DAD ratio of 7/6=1.167 is within the confidence level (1.14-1.19) of the panel test.

What is claimed is:

1. A wipe comprising:
a nonwoven fabric impregnated with a cleaning composition;
the nonwoven fabric having a basis weight of from about 70 to about 90 grams per square meter; a high basis weight area, and a low basis weight area, the weight ratio of the high basis weight area to the low basis weight area being from about 1.5 to about 4.0, the surface area ratio of the high basis weight area to the low basis weight area being from about 0.65 to about 1.60; the high basis weight areas and the low basis weight areas being distributed along the surface of the non-woven fabric in a repeating pattern; the repeat lengths of the pattern being from 2 to 6 mm in the cross direction (CD) and from 2 to 6 mm in the machine direction (MD).

2. The wipe of claim 1 wherein the weight ratio of the cleaning composition to the nonwoven fabric is from about 5.0 to about 6.0.

3. The wipe of claim 1 wherein the weight ratio of the cleaning composition to the nonwoven fabric is from about 5.3 to about 5.8.

4. The wipe of claim 1 wherein the weight ratio of the cleaning composition to the nonwoven fabric is about 5.5.

5. The wipe of claim 1, wherein the nonwoven fabric comprises polyester fibers and viscose fibers.

6. The wipe of claim 5, wherein the viscose fibers comprise from about 40% to 70%, by weight of the total weight of the nonwoven fabric, and the polyester fibers comprise from about 30% to 60%, by weight of the total weight of the nonwoven fabric.

7. The wipe of claim 5, wherein the viscose fibers comprise about 65% of the total weight of the nonwoven fabric, and the polyester fibers comprise about 35% of the total weight of the nonwoven fabric.

8. The wipe of claim 1, wherein the nonwoven fabric has a basis weight of about 80 grams per square meter.

9. The wipe of claim 1, wherein the weight ratio of the high basis weight areas to the low basis weight areas is about 2.7.

10. The wipe of claim 1 wherein the repeat length of the pattern is from 2 to 6 mm in the MD and CD directions.

11. The wipe of claim 1 wherein the cleaning composition comprises:
(i) from about 0.01% to about 0.05% by weight, of an anionic surfactant;
(ii) from about 0.01% to about 0.05% by weight of at least one nonionic surfactant; and
(iii) water, and optionally a perfume and adjuvant materials.

12. A method of cleaning a surface comprising contacting the surface to be cleaned with a wipe according to any of claims 1, 2, 3 or 5.

13. A package comprising a wipe according to any of claims 1, 2, 3 or 5 contained within a resealable water impermeable package.
